(19) United States
(12) Patent Application Publication
(10) Pub. No.: US 2003/0112745 A1
(43) Pub. Date: Jun. 19, 2003

(54) Method and system of operating a coded OFDM communication system

(76) Inventors: Xiangyang Zhuang, Hoffman Estates, IL (US); Frederick W. Vook, Schaumburg, IL (US); Stephanie Rouquette-Leveil, Massy (FR); Karine Gosse, Paris (FR)

Correspondence Address: MOTOROLA, INC., 1303 EAST ALGONQUIN ROAD, IL01/3RD, SCHAUMBURG, IL, 60196

(21) Appl. No.: 10/024,089

(22) Filed: Dec. 17, 2001

(51) Int. Cl. H04J 1/00

(52) U.S. Cl. 370/208; 370/343

(57) ABSTRACT

The invention provides a method of operating a coded OFDM communication system by interleaving a plurality of encoder output bits; mapping the interleaved bits to a plurality of modulated symbols; and forming a set of OFDM symbols for a plurality of transmit antennas based on the modulated symbols.

### FIELD OF THE INVENTION

In general, the present invention relates to the field of communication systems and more particularly, to the exploitation of space and frequency diversity in wireless communication systems.

### BACKGROUND OF THE INVENTION

In broadband wireless systems operating in high delay-spread environments, InterSymbol Interference (ISI) can cause severe frequency selectivity in the channel response. Equalizing or suppressing interference in a broadband channel with traditional time-domain techniques becomes a rather complex problem when the channel span becomes very long in relation to the symbol time. As a result, OFDM and frequency-domain equalization techniques have been proposed to combat the high level of ISI that is typically present in broadband channels.

In a multipath delay spread channel, the presence of multiple propagation paths provides a form of diversity that can be used by a receiver to combat the fading effects of the channel. In an ISI channel, different portions of the frequency band experience different fading processes, whereas in a flat non-ISI channel, the whole frequency band undergoes the same fading process. As a result, a delay-spread channel is said to have “frequency diversity,” whereas a flat channel is said to possess no frequency diversity.

In a broadband delay-spread channel, the available frequency diversity can be exploited in a number of ways. In OFDM, the most common technique is to employ error control coding across the subcarriers within an OFDM baud (also known as a symbol interval). Another technique for exploiting frequency diversity in OFDM is “spread OFDM,” where a user's data symbol is spread across the usable subcarriers using a Walsh sequence. On the other hand, in broadband single carrier systems, each time-domain data symbol occupies the entire system bandwidth, and proper equalization (performed either in the frequency domain or in the time domain) can exploit some frequency diversity in the process of mitigating the ISI. However, because the linear equalizer tries to compensate for channel variation in frequency, the decoder that follows the equalizer is unable to exploit any frequency diversity that was present in the channel.

In multipath channels, using multiple antennas at either the transmitter or the receiver can provide an additional form of diversity called “spatial diversity.” Spatial diversity, either in the form of transmit or receive diversity is another technique that can mitigate the deleterious effects of multipath fading in wireless communication systems. When the transmitted signal arrives at a multi-antenna receiver from multiple distinct angles of arrival, then optimally combining the signal received on multiple receive antennas can achieve receive-diversity. When the transmitted signal departs from a multi-antenna transmitter via multiple distinct angles of departure, then transmit diversity is said to be available in the channel. Various techniques are known in the art for exploiting transmit diversity, such as space-time coding and transmit array beamforming.

There is a significant need for a method and device for improving the operation of a coded OFDM communication system that can effectively take advantage of these different forms of diversity.

### BRIEF DESCRIPTION OF THE DRAWINGS

FIG. 1 is an overview diagram of one embodiment of a communication system in accordance with the present invention;

FIG. 2 is a block diagram illustrating a transmitting unit within the communication system of FIG. 1, in accordance with the present invention;

FIG. 3 is a block diagram illustrating a receiving unit within the communication system of FIG. 1, in accordance with the present invention; and

FIG. 4 is a flowchart diagram illustrating a method of communication between the transmitting unit of FIG. 2, and the receiving unit of FIG. 3, in accordance with the present invention.

### DETAILED DESCRIPTION OF A PREFERRED EMBODIMENT

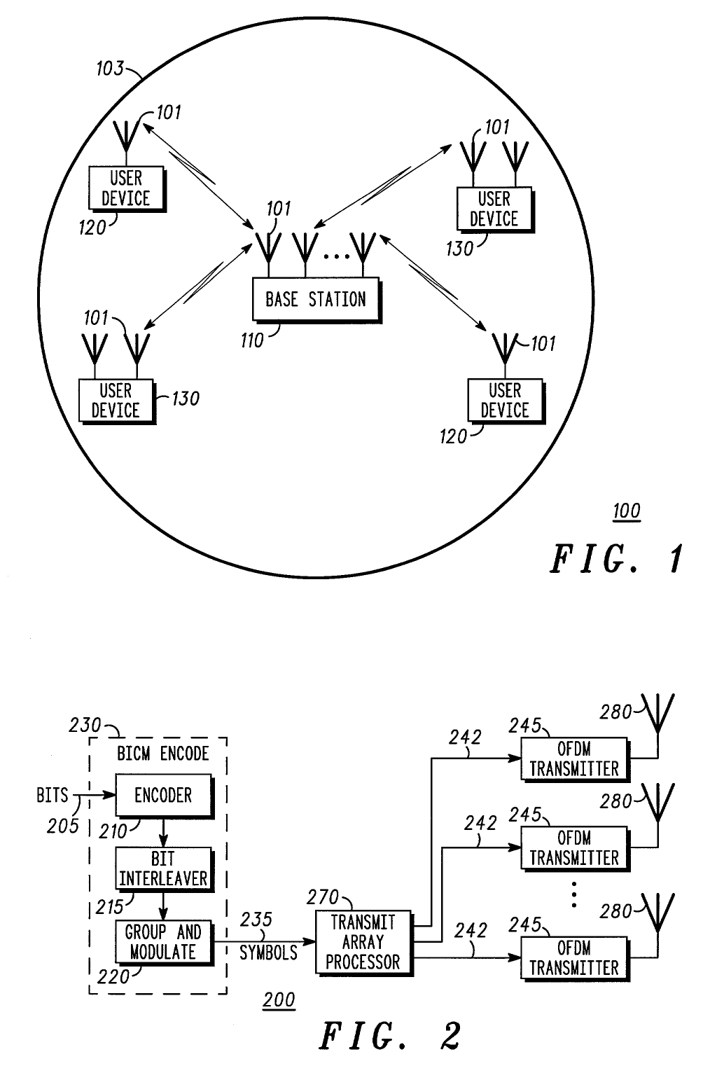

FIG. 1 illustrates a wireless communication system 100 in accordance with one embodiment of the present invention. As shown in FIG. 1, a base station 110 provides communication service to a geographic region known as a cell 103. At least one user device 120 and 130 communicate with the base station 110.

As shown in FIG. 1, user devices 120 have a single antenna 101, while user devices 130 have at least one antenna 101. One embodiment of the invention provides that the user devices 120 and 130, as well as the base station 110 may transmit, receive, or both from the at least one antenna 101. An example of this would be a typical cellular telephone. Additionally, one embodiment of the invention can be implemented as part of a base station 110 as well as part of a user device 120 or 130. Furthermore, one embodiment provides that user devices as well as base stations may be referred to as transmitting units, receiving units, transmitters, receivers, transceivers, or any like term known in the art, and alternative transmitters and receivers known in the art may be used.

One embodiment of the transmitting unit (transmitter) is further illustrated in FIG. 2. The transmitter 200 may be designed to utilize the frequency diversity provided by the variation of a frequency response within a typical broadband channel. When orthogonal frequency division multiplexing (OFDM) is used by the transmitter 200, such diversity may be exploited by using appropriate coding and interleaving across the frequency dimension. Since OFDM is a technique that may be designed to facilitate the compensation of a frequency-selective high delay spread channel, one embodiment of the design of the transmitter 200 may be targeted to this type of channel, although the design may also be robust to flat channels.

One embodiment of the transmitter 200 may incorporate Multiple Trellis Coded Modulation (MTCM), I-Q TCM, or Bit-Interleaved Coded Modulation (BICM), as these are good candidate codes that have a large “diversity factor.” These codes are based on trellis-coded modulation and can be decoded by the Viterbi algorithm as is known in the art. When used in the frequency domain in the OFDM context, these codes can exploit the frequency diversity in the channel.

BICM is of particular interest because it provides the largest diversity factor among those three candidate codes, and for one embodiment of the invention, may be included in an encoder 230 (BICM encoder). For one embodiment of the BICM encoder 230, the information bit sequence 205 may be encoded 210 by a convolutional code or a turbo code with a specified complexity (often decided by the number of trellis states for convolutional codes). The encoder output bit(s) sequence may then be interleaved 215 before being grouped 220 and mapped to M-QAM or MPSK symbols (modulated symbols) 235.

For one embodiment of the operation of the transmitter 200, it may be assumed that the modulation is the same for all the subcarriers, in which case the rate of the underlying code and the modulation order may determine the total data rate. Equivalently, a desired data rate can be obtained through choosing the code rate and the modulation order.

For one embodiment of the invention, it is desirable to achieve the best frequency diversity factor. Since it is known in the art what the best convolutional code for a certain code rate is in terms of providing the maximum d_{free} (where d_{free} is the minimum free distance), BICM may achieve this minimum diversity factor of d_{free} if the bit interleaver is designed properly. To achieve this minimum diversity factor within one embodiment of the invention, each one of d_{free} adjacent bits may be mapped to different symbols that are then sent on different OFDM subcarriers after being first processed (in another embodiment of the invention) by the transmit array processor 270. A frequency spacing between these different subcarriers can be larger than the channel coherence bandwidth to make the fading at those subcarriers as uncorrelated as possible. When the frequency spacing between these subcarriers is less then or equal to the channel coherence bandwidth, a performance degradation due to correlation may occur. For another embodiment of the transmitter 200 where different modulations are used on different subcarriers, the bit-to-symbol mapping operation of BICM needs to be performed in a manner consistent with the modulation being used, but the diversity factor d_{free} can still be achieved if the bit-interleaver is designed properly.

For any code that can be represented by a trellis, d_{free} may be the maximum among all the minimum diversity factors. For example, the diversity factor for TCM (including space-time TCM) is └m/k┘+1 for a 2^{m}-state code of rate k b/s/Hz, where └a┘ denotes the largest integer less than a. In general, this value may be well less than the d_{free} achieved by BICM.

For another embodiment of the invention, BICM may be implemented on the in-phase and quadrature dimensions separately, as an I-Q BICM. In this embodiment, two bit sequences can be coded and mapped independently as in BICM. The two resulting real-valued symbol sequences specify the in-phase and quadrature part of the transmitted signal, respectively. The receiver can compensate for the phase shift of the channel first before decoding, as will be elaborated later. An advantage of I-Q BICM is that decoding complexities may be reduced with a very small performance penalty.

Another embodiment of the invention may allow for the design of the spatial dimension of the transmitted signal to be separated from the design in the frequency dimension. The transmit array processor 270 processes the symbols 235 and may compute a plurality of array-processed symbols 242 that can be fed to a plurality of OFDM transmission units 245. Each output of an OFDM transmission unit may be connected to a transmit antenna 280. One embodiment of the invention may allow the transmit array processor 270 to exploit any spatial diversity that may be present in the multipath channel. Transmit array processing (which may include transmit diversity techniques, space-time coding processing, or transmit array beamforming, or other related antenna array transmission techniques) occurs at the symbol level and may be performed for each subcarrier 270 in OFDM. The spatial dimension design may exploit the spatial diversity as much as possible. Depending on the number of transmit antennas 280, there are several schemes that can be performed by the transmit array processor 270 for achieving the optimal exploitation of the transmit spatial diversity.

Defining M_{T} as the number of transmit antennas and M_{R} the number of receive antennas, there exists an elegant scheme that achieves optimal spatial diversity combining at a “full” symbol rate (i.e., one symbol per channel use) for M_{T}=2 and M_{R}≧1. The scheme is an orthogonal space-time block code referred to as the Alamouti scheme after the inventor. The Alamouti scheme can be used in the context of flat channels, which may be the case on a particular OFDM sub-channel. For every two adjacent OFDM symbols (bauds), the Alamouti scheme can be implemented straightforwardly as such:

“during the k^{th} baud, the first and second antennas send BICM-encoded symbol sequence s(k) and s(k+1) on a set of subcarriers, while the two antennas send −s*(k+1) and s*(k) during the (k+1)^{th} baud, respectively, where the notation (·)* denotes the conjugation of each component.”

Another embodiment of the transmit array processor 270 may include orthogonal space-time block coding designs that achieve optimal spatial combining when M_{T}>2, but “full” rate may not be possible in all cases. In an embodiment of the invention utilizing orthogonal designs, static channels may be required for optimal performance during M_{T} consecutive OFDM bauds.

If the transmitter has more than one antenna and is provided knowledge of the channel response (channel estimate) between each transmit antenna and each receive antenna, then other transmit array processing schemes may be used by the transmit array processor 270. For example, maximal ratio transmission, or transmit beamforming may be used to improve performance by providing not only a transmit spatial diversity gain, but a coherent beamforming gain as well.

One embodiment of the invention provides baseband processing by a receiver as described in the block diagram illustrating a receiving unit 300 in FIG. 3. Each OFDM receiver 315 can receive data from its associated antenna 340. Fast Fourier Transformed (FFT'd) data (FFT output symbols 310) at the output of each OFDM receiver 315 can be sent to a receive array processor 328, which can perform receive array combining for the purposes of exploiting receive diversity and/or suppressing interference via one of many receive antenna array processing techniques. The antenna array processing techniques may include, but are not limited to, minimum mean square error combining, zero-forcing combining, maximum likelihood symbol detection, successive interference cancellation, joint detection, and other similar or related techniques known in the art. The receive array processor 328 may produce array processor output symbols 317 that may be used to compute symbol metrics and then to generate bit metrics 305. Bit metrics may be derived from symbol metrics as is known in the art. For convolutional codes, the bit metric may be set as the minimum among a set of symbol metrics, where the minimum is taken over a symbol set consisting of all the constellation symbols whose binary label has, at the proper position, the bit (0 or 1) being specified by the trellis branch. The bit metrics can be de-interleaved 320 according to the specified interleaving pattern, and then they are used in the decoder. A BICM decoder 330 within one embodiment of the invention may employ a Viterbi decoder 325 for a convolutional code. The Viterbi decoder computes the metric for each branch in the code trellis and accumulates branch metrics along the paths in the trellis. Each branch metric is the sum of bit metrics of those bits associated with that branch.

For an embodiment of the invention with multiple receive antennas 340 and/or multiple transmit antennas 280 in FIG. 2, the received FFT data 310 may be pre-processed 328 at each OFDM subcarrier before being fed in to the decoder. In the embodiment of the invention using the Alamouti technique, the received FFT data 310 at the k^{th} and (k+1)^{th} baud on the i^{th} subcarrier are denoted by the vectors yᵢ(k) and yᵢ(k+1) respectively and are given by the equation:

$$[ \begin{matrix}{y}_{i} & ( k ) \\ {y}_{i}^{*} & ( k + 1 )\end{matrix} ] = [ \begin{matrix}{h}_{i , 0} ( k ) & {h}_{i , l} ( k ) \\ {h}_{i , l}^{*} ( k + 1 ) & - {h}_{i , 0}^{*} ( k + 1 )\end{matrix} ] [ \begin{matrix}{s}_{i} & ( k ) \\ {s}_{i} & ( k + 1 )\end{matrix} ] + [ \begin{matrix}{n}_{i} ( k ) \\ {n}_{i}^{*} ( k + 1 )\end{matrix} ] , \qquad ( 1 )$$

where h_{i,0}(k) and h_{i,1}(k) are M_{R}-by-1 vectors of the channel coefficients from the first and second transmit antenna to the M_{R} receive antennas, respectively, both at subcarrier i of the k^{th} baud. Also in this equation, nᵢ(k) denotes the noise signal at the k^{th} baud on the i^{th} subcarrier. The notation (·)* denotes the conjugation of each component.

The pre-processing 328 may consist of two linear filters (or equivalently two linear weighting vectors) that, when applied to [yᵢ^{T}(k), yᵢ^{H}(k+1)]^{T}, will perfectly cancel the cross-interference between the two signals sent from the two (or more depending on the transmission scheme) transmit antennas 280 and at the same time optimally combine the spatial diversity. Assuming the channel does not change during the two adjacent bauds so that h_{i,0}(k)=hᵢ₀(k+1)=h_{1,0}, the two linear filters and their outputs 317 are given in the following equation:

$$[ \begin{matrix}{z}_{i} ( k ) \\ {z}_{i} ( k + 1 )\end{matrix} ] {\underline{\underline{Δ}} [ \begin{matrix}{h}_{i , 0} & {h}_{i , 1} \\ {h}_{i , 1}^{*} & - {h}_{i , 0}^{*}\end{matrix} ]}^{H} [ \begin{matrix}{y}_{i} ( k ) \\ {y}_{i}^{*} ( k + 1 )\end{matrix} ] = ( ‖ {h}_{i , 0} {‖}^{2} + ‖ {h}_{i , 1} {‖}^{2} ) [ \begin{matrix}{s}_{i} ( k ) \\ {s}_{i} ( k + 1 )\end{matrix} ] + [ \begin{matrix}{n}_{i}^{′} ( k ) \\ {n}_{i}^{′} ( k + 1 )\end{matrix} ] \qquad ( 2 )$$

where ∥·∥ denotes the vector norm.

It appears that |zᵢ(k)−(∥h_{i,0}∥²+∥h_{i,1}∥²)\check{s}|² can be used as the symbol metric in the Viterbi decoder for any \check{s} in the symbol constellation. However, the linear filtering (performed by the array processor 328) may influence the output noise power in the array processor output symbols 317. Assuming spatially white Gaussian noise, it is easy to see that the variance of output noise n′ᵢ(k) is (∥h_{i,0}∥²+∥h_{i,1}∥²)σₙ², which varies according to the subcarrier i. So, for the Viterbi decoder to be able to sum up the metrics along the trellis, n′ᵢ(k) must be normalized by dividing n′ᵢ(k) with the square-root of (∥h_{i,0}∥²+∥h_{i,1}∥²), i.e., the metric should be defined as the equation:

$$( ‖ {h}_{i , 0} {‖}^{2} + {‖ {h}_{i , 1} ‖}^{2} ) {\vert \frac{{z}_{i} ( k )}{( {‖ {h}_{i , 0} ‖}^{2} + {‖ {h}_{i , 1} ‖}^{2} )} - \breve{s} \vert}^{2} \qquad ( 3 )$$

Since zᵢ(k)l(∥h_{i,0}∥²+∥h_{i,1}∥²) is also the symbol estimation of a zero-forcing (ZF) filter based on the model (1), this metric can be viewed as the distance between the estimated symbol and \check{s}, weighted by the inverse of the squared norm of the filter.

The idea of modifying the bit metric can also be applied to other embodiments of the invention, such as when a linear MMSE filter is used instead of a ZF filter in the array processor 328. Another embodiment of the invention that may apply the modified bit metric may have one transmit antenna and at least one receive antenna, where a maximum ratio combiner in the receiver array processor 328 gives the equation:

zᵢ=hᵢ^{H}yᵢ=∥hᵢ∥²sᵢ+hᵢ^{H}nᵢ (4)

where (·)^{H} denotes vector transpose and conjugation, so the metric should be the following equation:

$$‖ {h}_{i} {‖}^{2} {\vert \frac{{z}_{i}}{{‖ {h}_{i} ‖}^{2}} - \breve{s} \vert}^{2} . \qquad ( 5 )$$

When I-Q BICM is used, the real and imaginary components of the transmitted signal sᵣ+jsᵢ can interfere with each other (i.e., result in cross-talk) in the received data r=h(sᵣ+jsᵢ)+N, since the channel response h is a complex value. Only when h is a real value can the in-phase and quadrature part of r be used directly to decode sᵣ and sᵢ in parallel. A “de-rotate” operation of rh*/|h| can turn the effective channel into a real-valued channel. In the case of the Alamouti scheme, one embodiment of the invention may provide the “de-rotation” using linear filters (refer to (2)). The maximum ratio combiner may also “de-rotate” the channel.

The I-Q BICM decoder is simpler than BICM, because a bit metric is derived from a smaller symbol set. For example, a 16-QAM BICM decoder needs to compare between eight symbol metrics in the computation of a bit metric. But for I-Q TCM, since each encoder in the I-Q TCM scheme assumes a real-valued modulation (4-AM), the decoder in each branch needs to compare between metrics of four constellation symbols.

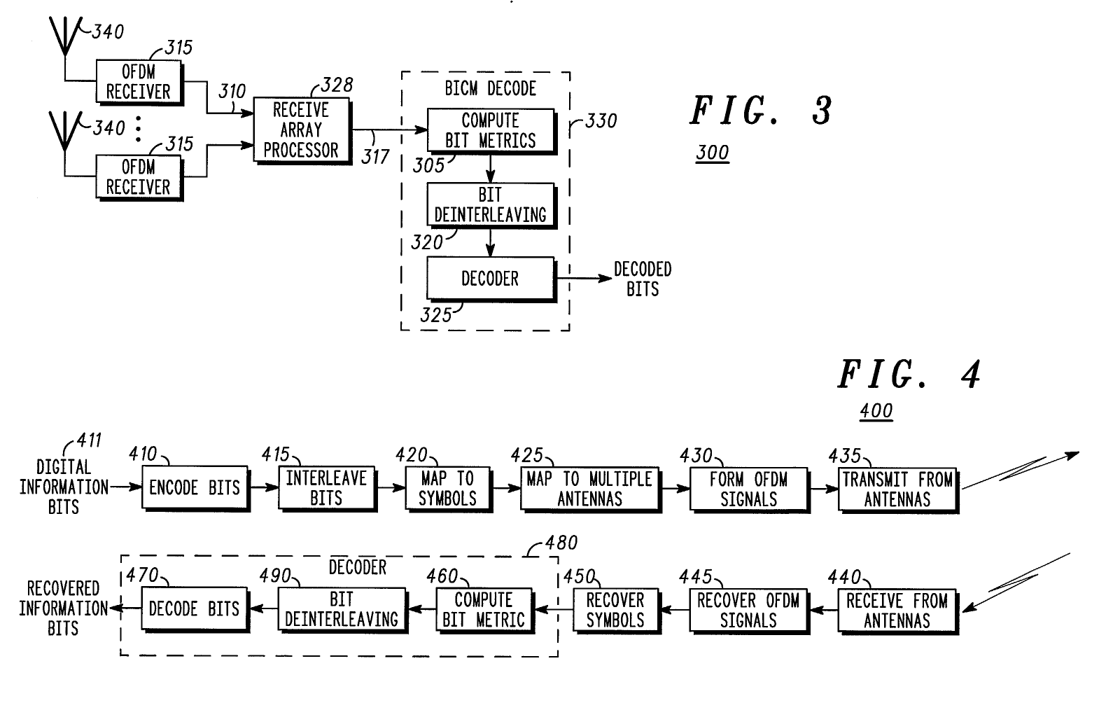

Illustrated in FIG. 4 is a flowchart diagram for one embodiment of a method of communication 400 between the transmitting unit 200 and the receiving unit 300. The boxes 415, 420, 425, 450, 460, and 490 represent operations previously described in the detailed description of the invention. After encoding 410 the digital information bits 411, the encoded bits may be interleaved 415. In one embodiment of the invention, the interleaver may be designed such that, for any block of length-d_{free} bits within the encoded bit sequence, each bit of that block is eventually transmitted from a different subcarrier. An additional embodiment of the invention may provide that these different subcarriers are chosen so that the channel responses between the transmitter and the receiver on those subcarriers are minimally correlated to each other.

Consecutive blocks of interleaved bits may next be mapped to transmission symbols 420. Each symbol may be transmitted on a certain OFDM subcarrier 430 from a certain antenna 435. The step of mapping to a plurality of antennas 425 may be performed as an orthogonal space-time block code, which includes the methods previously described for FIG. 2. Additionally, the transmit weighting may be based on channel estimates (transmit beamforming or maximal ratio transmission).

Receiving the transmitted data through multiple antennas 440 and recovering the OFDM signals 445 are all performed as is known in the art. The step of recovering symbols 450 depends on the configuration of the mapping block 425, and this step can be implicitly included in the step of computing the bit metrics in block 460. The bit metrics, derived from the symbol metrics, may be de-interleaved 490. The decoder 480 may continue to decode the de-interleaved bits 470 to produce the recovered information bits 490 using techniques known in the art.

In the case where the step of recovering symbols is performed explicitly, a linear weight vector (filter) of wᵢ^{T} is applied to a signal vector xᵢ at the subcarrier indexed by i, where xᵢ and wᵢ are column vectors of the same length, and (·)^{T} denotes the transpose of a vector. In the example of the Alamouti technique, the signal vector is xᵢ=[yᵢ^{T}(k)yᵢ^{H}(k+1)]^{T} (refer to (1)) and the two linear filters are (refer to (2))

wᵢ^{T}(k)=[h_{i,0}^{H}, h_{i,1}^{T}]/(∥h_{i,0}∥²+∥h_{i,1}∥²) wᵢ^{T}(k+1)=[h_{i,1}^{H}, −h_{i,0}^{T}]/(∥h_{i,0}∥²+∥h_{i,1}∥²)′ (6)

In the example of receiver maximum ratio combining, the signal vector is xᵢ=yᵢ (refer to (4)) and the linear filter is just wᵢ^{T}=hᵢ^{H} (refer to (5)). After recovering the symbols, symbol metrics are then computed, based on which bit metrics are derived. If a convolutional encoder is used, the symbol-level metric may be the equation:

$$\frac{1}{{‖ {w}_{i} ‖}^{2}} {\vert {w}_{i}^{T} {x}_{i} - \breve{s} \vert}^{2} , \qquad ( 7 )$$

where ∥·∥² is the squared norm of a vector, i.e., the sum of the squared magnitude of each elements in the vector, \check{s} is the nominal symbol in the symbol constellation. The symbol-level metrics can be used to derive the bit-level metrics, as previously described for FIG. 3. If a concatenated convolutional encoder is used, including serially concatenated and parallel concatenated encoders (both also known as turbo codes), the logarithm of the probability may be used as the metric. The symbol-level metric for “turbo” codes may be the equation:

$$\frac{1}{{‖ {w}_{i} ‖}^{2} {σ}^{2}} {\vert {w}_{i}^{T} {x}_{i} - \breve{s} \vert}^{2} , \qquad ( 8 )$$

where σ² is the noise power. From the symbol-level metric, bit metrics may be derived as known in the art. The principal behind metric (7) and (8) is to account for the effective noise signal that is affected by the filtering process of wᵢ^{T}.

The “recover symbols” step 450 can be implicit, in which case wᵢ^{T} will not be formed and applied explicitly. For example, in the Alamouti case, equation (6) can be plugged directly into the metric equations (7) and (8) without explicitly computing wᵢ^{T}xᵢ. Note that plugging (6) into (7) results in (3).

When the transmitter performs transmit antenna weighting based on channel estimates (i.e., transmit beamforming or Maximal Ratio Transmission), then a set of weights is applied to each transmit antenna at a subcarrier with an index of i, and the corresponding weight vector is denoted as vᵢ and may be computed based on the estimates of the channel response matrix between the transmit array and the receive array. In this case, the metrics (7) and (8) may still hold unchanged if a filter wᵢ^{T} still applied, i.e., the metrics depend only on the receive filter but not the weighting vᵢ. In the case where there is only one receive antenna, xᵢ is just a scalar and wᵢ^{T}=1. In the case of more than one receive antennas, wᵢ^{T} is a weight vector that can be computed based on the channel response matrix.

The above-described methods and implementation of encoding and decoding are example methods and implementations. These methods and implementations illustrate one possible approach for operating a coded OFDM communication system. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim

1. A method of operating a coded OFDM communication system comprising:
interleaving a plurality of encoder output bits;
mapping the interleaved bits to a plurality of modulated symbols; and
forming a set of OFDM symbols for a plurality of transmit antennas based on the modulated symbols.

2. The method of claim 1 wherein the set of OFDM symbols for the plurality of transmit antennas is formed based on an orthogonal space-time block code.

3. The method of claim 1 wherein the set of OFDM symbols for the plurality of transmit antennas is formed based on at least one channel estimate between the transmitter and receiver.

4. The method of claim 1 wherein the encoder is based on bit-interleaved coded modulation schemes based on convolutional codes.

5. The method of claim 1 wherein the encoder is based on bit-interleaved coded modulation schemes based on turbo codes.

6. The method of claim 1 wherein the encoder is based on a multiple trellis coded modulation scheme.

7. The method of claim 1 further comprising:
receiving at least one signal from the transmit antennas;
determining a decoder bit metric based on an effective noise signal;
de-interleaving the bit metrics; and
decoding the received signal based on the de-interleaved bit metric.

8. The method of claim 7 wherein the received signal satisfies the relationship:
$$[ \begin{matrix}{y}_{i} ( k ) \\ {y}_{i}^{*} ( k + 1 )\end{matrix} ] = [ \begin{matrix}{h}_{i , 0} ( k ) & {h}_{i , 1} ( k ) \\ {h}_{i , 1}^{*} ( k + 1 ) & - {h}_{i , 0}^{*} ( k + 1 )\end{matrix} ] [ \begin{matrix}{s}_{i} ( k ) \\ {s}_{i} ( k + 1 )\end{matrix} ] + [ \begin{matrix}{n}_{i} ( k ) \\ {n}_{i}^{*} ( k + 1 )\end{matrix} ]$$

9. The method of claim 7 further comprising filtering the received signal according to the equation:
$$[ \begin{matrix}{z}_{i} ( k ) \\ {z}_{i} ( k + 1 )\end{matrix} ] {\underline{\underline{Δ}} [ \begin{matrix}{h}_{i , 0} & {h}_{i , 1} \\ {h}_{i , 1}^{*} & - {h}_{i , 0}^{*}\end{matrix} ]}^{H} [ \begin{matrix}{y}_{i} ( k ) \\ {y}_{i}^{*} ( k + 1 )\end{matrix} ] = \\ ( {‖ {h}_{i , 0} ‖}^{2} + {‖ {h}_{i , 1} ‖}^{2} ) [ \begin{matrix}{s}_{i} ( k ) \\ {s}_{i} ( k + 1 )\end{matrix} ] + [ \begin{matrix}{n}_{i}^{′} ( k ) \\ {n}_{i}^{′} ( k + 1 )\end{matrix} ]$$

10. The method of claim 7 further comprising decoding the received signal according to the equation:
$$( {‖ {h}_{i , 0} ‖}^{2} + {‖ {h}_{i , 1} ‖}^{2} ) {\vert \frac{{z}_{i} ( k )}{( {‖ {h}_{i , 0} ‖}^{2} + {‖ {h}_{i , 1} ‖}^{2} )} - \breve{s} \vert}^{2}$$

11. The method of claim 7 wherein the decoder metric is based on the equation:
$${‖ {h}_{i} ‖}^{2} {\vert \frac{{z}_{i}}{{‖ {h}_{i} ‖}^{2}} - \breve{s} \vert}^{2}$$

12. The method of claim 7 wherein the decoder metric is based on at least one channel estimate between the transmitter and receiver.

13. The method of claim 7 wherein the decoder bit metric is based on a symbol metric for convolutional codes given by:
$$\frac{1}{{‖ {w}_{i} ‖}^{2}} \vert {w}_{i}^{T} {x}_{i} - \breve{s} {\vert}^{2} \cdot$$

14. The method of claim 13 wherein wᵢ is computed based on the channels between each transmit antenna and each receive antenna.

15. The method of claim 13 wherein wᵢ is computed according to
wᵢ^{T}(k)=[h_{i,0}^{H}, h_{i,1}^{T}]/(∥h_{i,0}∥²+∥h_{i,1}∥²) wᵢ^{T}(k+1)=[h_{i,1}^{H}, −h_{i,0}^{T}]/(∥h_{i,0}∥²+∥h_{i,1}∥²)^{.}

16. The method of claim 13 wherein wᵢ is computed according to wᵢ^{T}=hᵢ^{H}.

17. The method of claim 7 wherein the decoder bit metric is based on a symbol metric for turbo codes given by:
$$\frac{1}{{‖ {w}_{i} ‖}^{2} {σ}^{2}} \vert {w}_{i}^{T} {x}_{i} - \breve{s} {\vert}^{2}$$
where σ² is a noise power.

18. The method of claim 17 wherein wᵢ is computed based on the channels between each transmit antenna and each receive antenna.

19. The method of claim 17 wherein wᵢ is computed according to:
wᵢ^{T}(k)=[h_{i,0}^{H}, h_{i,1}^{T}]/(∥h_{i,0}∥²+∥h_{i,1}∥²) wᵢ^{T}(k+1)=[h_{i,1}^{H}, −h_{i,0}^{T}]/(∥h_{i,0}∥²+h_{i,1}∥²)^{.}

20. The method of claim 17 wherein wᵢ is computed according to wᵢ^{T}=hᵢ^{H}.

21. The method of claim 7 wherein the decoder metric is based on a space-time block code.

22. The method of claim 7 wherein the decoded signal is based on the viterbi algorithm.

23. The method of claim 7 wherein the decoder metric is a function of a zero-forcing filter.

24. The method of claim 7 wherein the decoder metric is a function of a Minimum Mean Square Error filter.

25. A system for operating a coded OFDM communication system comprising:
means for interleaving a plurality of encoder output bits;
means for mapping the interleaved bits to a plurality of modulated symbols; and
means for forming a set of OFDM symbols for a plurality of transmit antennas based on the modulated symbols.

26. The system of claim 25 further comprising:
means for receiving at least one signal from the transmit antennas;
means for determining a decoder bit metric based on an effective noise signal;
means for de-interleaving the bit metrics; and
means for decoding the received signal based on the de-interleaved bit metric.

27. A computer readable medium storing a computer program comprising:
computer readable code for interleaving a plurality of encoder output bits;
computer readable code for mapping the interleaved bits to a plurality of modulated symbols; and
computer readable code for forming a set of OFDM symbols for a plurality of transmit antennas based on the modulated symbols.

28. The computer readable medium of claim 27 further comprising:
computer readable code for receiving at least one signal from the transmit antennas;
computer readable code for determining a decoder bit metric based on an effective noise signal;
computer readable code for de-interleaving the bit metrics; and
computer readable code for decoding the received signal based on the de-interleaved bit metric.
